(19) United States
(12) Patent Application Publication
(10) Pub. No.: US 2025/0385334 A1
(43) Pub. Date: Dec. 18, 2025

(54) CONTROL APPARATUS FOR ELECTRICITY STORAGE APPARATUS

(71) Applicant: TOYOTA JIDOSHA KABUSHIKI KAISHA, Toyota-shi (JP)

(72) Inventor: Naoya GOTOH, Seto-shi (JP)

(73) Assignee: TOYOTA JIDOSHA KABUSHIKI KAISHA, Toyota-shi (JP)

(21) Appl. No.: 19/040,874

(22) Filed: Jan. 30, 2025

(30) Foreign Application Priority Data
Jun. 17, 2024 (JP) 2024-097500

(51) Int. Cl. H01M 10/633; H01M 10/48; H01M 10/615

(52) U.S. Cl. CPC H01M 10/633; H01M 10/486; H01M 10/615

(57) ABSTRACT

An ECU is a control apparatus for an electricity storage system. The electricity storage system includes a battery cell, a temperature sensor, and a cooling and temperature raising device. The ECU includes a CPU. The CPU determines an estimated maximum value of the temperature difference between the detected temperature and the electrode temperature of the battery cell, and an estimated required time period required for the temperature difference to reach the maximum value. When a temperature raising duration exceeds the estimated required time period, the CPU reduces a temperature difference estimated value of the temperature difference between the temperature detected by the temperature sensor and the electrode temperature while causing the temperature raising to be continued to increase an electrode temperature estimated value of the battery cell and increase a charging electric power limit value of the battery cell corresponding to the electrode temperature estimated value.

### CROSS-REFERENCE TO RELATED APPLICATION

This application claims priority to Japanese Patent Application No. 2024-097500 filed on Jun. 17, 2024. The disclosure of the above-identified application, including the specification, drawings, and claims, is incorporated by reference herein in its entirety.

### BACKGROUND

### 1. Technical Field

The present disclosure relates to a control apparatus for an electricity storage apparatus, and particularly relates to a control apparatus for an electricity storage apparatus including a secondary battery, a temperature sensor, and a temperature raising device.

### 2. Description of Related Art

A conventional technique measures the surface temperature of a secondary battery, and limits charging electric power in a predetermined period during and after raising of the temperature of the secondary battery (e.g., refer to Japanese Unexamined Patent Application Publication No. 2018-116846 (JP 2018-116846 A)).

### SUMMARY

The technique of JP 2018-116846 A has such a problem that the period required for charging increases due to the use of a map for limiting charging electric power with a margin for the temperature difference between the surface temperature and the internal temperature of the secondary battery.

The present disclosure has been made to solve the above problem, and an object thereof is to provide a control apparatus for an electricity storage apparatus that can shorten the period required for charging.

A control apparatus according to the present disclosure is a control apparatus for an electricity storage apparatus. The electricity storage apparatus includes a secondary battery, a temperature sensor that detects a temperature of the secondary battery, and a temperature raising device that raises the temperature of the secondary battery. The control apparatus includes a processor. The processor determines, from a temperature detected by the temperature sensor when the temperature raising device starts temperature raising, an estimated maximum value of a temperature difference between the detected temperature and an electrode temperature of the secondary battery, and an estimated required time period required for the temperature difference to reach the estimated maximum value, and reduces a temperature difference estimated value of the temperature difference between the temperature detected by the temperature sensor and the electrode temperature while causing the temperature raising to be continued to increase an electrode temperature estimated value of the secondary battery and increase a charging electric power limit value of the secondary battery corresponding to the electrode temperature estimated value when a temperature raising duration of the temperature raising performed by the temperature raising device exceeds the estimated required time period.

With such a configuration, from the temperature detected by the temperature sensor when the temperature raising is started, the estimated maximum value of the temperature difference between the detected temperature and the electrode temperature of the secondary battery and the estimated required time period required for the temperature difference to reach the estimated maximum value are determined. When the temperature raising duration exceeds the estimated required time period, the temperature difference estimated value of the temperature difference between the temperature detected by the temperature sensor and the electrode temperature is reduced while the temperature raising is continued, thereby increasing the electrode temperature estimated value of the secondary battery and increasing the charging electric power limit value of the secondary battery corresponding to the electrode temperature estimated value. Thus, it is possible to increase the charging electric power of the secondary battery from the estimated timing at which the temperature difference between the temperature detected by the temperature sensor and the electrode temperature starts to decrease. As a result, it is possible to provide the control apparatus for the electricity storage apparatus that can shorten the period required for charging.

The control apparatus may further include a storage unit. The storage unit may store in advance a map showing the estimated maximum value and the estimated required time period for each temperature detected by the temperature sensor at the start of the temperature raising. The processor may determine the estimated maximum value and the estimated required time period using the map stored in the storage unit.

With such a configuration, it is possible to more appropriately determine the estimated maximum value and the estimated required time period.

When the temperature difference estimated value falls below a predetermined value after the temperature raising duration exceeds the estimated required time period, the processor may adjust the temperature difference estimated value to the predetermined value.

With such a configuration, since the temperature difference estimated value of the temperature difference between the temperature detected by the temperature sensor and the electrode temperature is calculated by estimation, it is possible to prevent the charging electric power limit value that is increased in accordance with the temperature difference estimated value from being increased too much.

When the temperature difference estimated value becomes zero after the temperature raising duration exceeds the estimated required time period, the processor may cause the temperature raising device to finish the temperature raising.

With such a configuration, when the temperature difference estimated value of the temperature difference between the temperature detected by the temperature sensor and the electrode temperature becomes zero and the temperature raising device does not need to perform the temperature raising, it is possible to save electric power consumed by the temperature raising device.

When the temperature raising duration does not exceed the estimated required time period, the processor may set the temperature difference estimated value at the estimated maximum value while causing the temperature raising to be continued to maintain the electrode temperature estimated value of the secondary battery at the start of the temperature raising unchanged and maintain the charging electric power limit value corresponding to the electrode temperature estimated value constant.

With such a configuration, it is possible to prevent the charging electric power limit value from being inadvertently increased when it is unclear that the temperature difference estimated value of the temperature difference between the temperature detected by the temperature sensor and the electrode temperature has decreased.

The present disclosure can provide the control apparatus for the electricity storage apparatus that can shorten the period required for charging.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an entire configuration diagram of an electricity storage system according to an embodiment;

FIG. 2 is a flowchart showing the flow of a battery temperature estimating process of the embodiment; and

FIG. 3 is a graph showing changes in the difference between the internal temperature and the external temperature of a battery cell of a battery in the embodiment.

### DETAILED DESCRIPTION OF EMBODIMENTS

Hereinbelow, an embodiment of the present disclosure will be described in detail with reference to the drawings. Note that identical or corresponding parts in the drawings will be designated by the same reference signs, and description thereof will not be repeated.

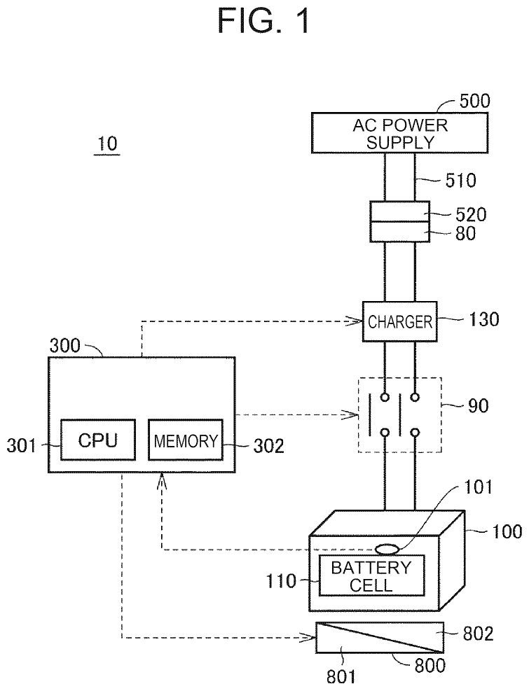

FIG. 1 is an entire configuration diagram of an electricity storage system 10 according to the embodiment. The electricity storage system 10 may be mounted on an electrified vehicle, such as a battery electric vehicle (BEV), a hybrid electric vehicle (HEV), a plug-in hybrid electric vehicle (PHEV), or a fuel cell electric vehicle (FCEV), or may be mounted on a stationary storage battery.

The electricity storage system 10 includes a battery 100, an electronic control unit (ECU) 300, a cooling and temperature raising device 800, an AC inlet 80, a charger 130, and a charging relay 90.

The battery 100 is a direct current power source (secondary battery) that stores electric power and is rechargeable. The battery 100 includes a plurality of battery cells 110 stacked. For example, the battery cells 110 are electrically connected in series. Each battery cell 110 is, for example, a lithium ion battery. Each battery cell 110 may be a nickel metal hydride battery or an all-solid-state battery. Each battery cell 110 is provided with a temperature sensor 101. The temperature sensor 101 may be provided in any part of the battery cell 110. For example, the temperature sensor 101 is provided on the surface of the battery cell 110. The temperature sensor 101 detects the temperature of the battery cell 110 and outputs a signal indicating the temperature to the ECU 300.

The AC inlet 80 is configured to be connectable with a connector 520 that is provided at a tip of a charging cable 510 of an external AC power supply (EVSE) 500. The charger 130 is provided on a power line between the AC inlet 80 and the battery 100. The charger 130 converts alternating current electric power supplied from the external AC power supply 500 into direct current electric power and also converts the voltage of the electric power into a voltage at which the battery 100 can be charged. The charging relay 90 is electrically connected to a power line that connects the charger 130 and the battery 100 to each other. The charging relay 90 switches supply and interruption of electric power between the charger 130 and the battery 100 in accordance with a control signal from the ECU 300. When the charging relay 90 is closed, external charging of the battery 100 is executed. Although the electricity storage system 10 can perform AC charging, this is not a limitation. The electricity storage system 10 may include a DC inlet and may be configured to perform DC charging.

The ECU 300 includes a central processing unit (CPU) 301, and a memory (including, for example, a read only memory (ROM) and a random access memory (RAM)) 302. The ECU 300 controls each part of the electricity storage system 10 such that the electricity storage system 10 is brought into a desired state, based on signals (e.g., current signals and voltage signals) from various sensors, and information of maps and programs stored in the memory 302. In addition, the ECU 300 controls the charger 130, the charging relay 90, and the cooling and temperature raising device 800.

The cooling and temperature raising device 800 adjusts the temperature of the battery 100. The cooling and temperature raising device 800 includes a battery cooling unit (battery cooling system) 801 and a battery temperature raising unit (battery temperature raising system) 802. It is only required that the cooling and temperature raising device 800 be capable of cooling the battery 100 and raising the temperature of the battery 100. The cooling and temperature raising device 800 may perform air cooling (heat exchange using gas as a medium) or liquid cooling (heat exchange using liquid as a medium), and may use heat generated by charging and discharging the battery 100.

A conventional technique measures the surface temperature of a secondary battery, such as the battery cell 110 of the battery 100, and limits charging electric power in a predetermined period during and after raising of the temperature of the secondary battery. The conventional technique has such a problem that the period required for charging increases due to the use of a map for limiting charging electric power with a margin for the temperature difference between the surface temperature and the internal temperature of the secondary battery.

When the internal temperature of the battery cell 110 is low, it is necessary to limit the charging and discharging electric power to restrain deterioration of the battery cell 110. In particular, in the case of a lithium ion battery, it is necessary to limit the charging and discharging electric power to restrain deposition of lithium metal on a negative electrode at low temperatures.

Furthermore, when the temperature of the battery cell 110 is raised by applying heat to the battery cell 110 from the outside thereof, the surface temperature becomes higher than the internal temperature at the start of the temperature raising. Thus, it is desirable to make a charging electric power limit value and a discharging electric power limit value that are actually used in control smaller than a charging electric power limit value and a discharging electric power limit value corresponding to the temperature detected by the temperature sensor 101 attached to the surface of the battery cell.

Thus, from the temperature detected by the temperature sensor 101 when the cooling and temperature raising device 800 starts temperature raising, the CPU 301 determines an estimated maximum value of the temperature difference between the detected temperature and the electrode temperature of the battery cell 110 of the battery 100 and an estimated required time period required for the temperature difference to reach the estimated maximum value. When a temperature raising duration of the temperature raising performed by the cooling and temperature raising device 800 exceeds the estimated required time period, the CPU 301 reduces a temperature difference estimated value of the temperature difference between the temperature detected by the temperature sensor 101 and the electrode temperature while causing the temperature raising to be continued, thereby increasing an electrode temperature estimated value of the battery cell 110 of the battery 100 and increasing the charging electric power limit value of the battery 100 corresponding to the electrode temperature estimated value.

Accordingly, from the temperature detected by the temperature sensor 101 when the temperature raising is started, the estimated maximum value of the temperature difference between the detected temperature and the electrode temperature of the battery cell 110 of the battery 100 and the estimated required time period required for the temperature difference to reach the estimated maximum value are determined. When the temperature raising duration exceeds the estimated required time period, the temperature difference estimated value of the temperature difference between the temperature detected by the temperature sensor 101 and the electrode temperature is reduced while the temperature raising is continued, thereby increasing the electrode temperature estimated value of the battery cell 110 of the battery 100 and increasing the charging electric power limit value of the battery 100 corresponding to the electrode temperature estimated value. Thus, it is possible to increase the charging electric power of the battery 100 from the estimated timing at which the temperature difference between the temperature detected by the temperature sensor 101 and the electrode temperature starts to decrease. As a result, the period required for charging can be shortened.

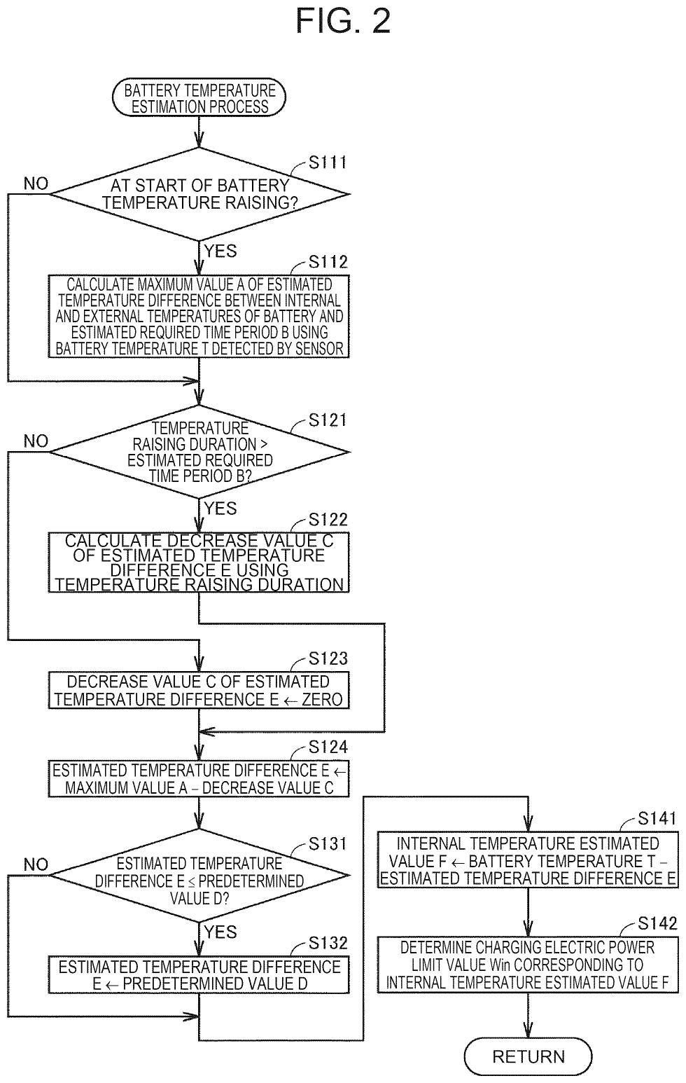

FIG. 2 is a flowchart showing the flow of a battery temperature estimation process in the present embodiment. Referring to FIG. 2, the battery temperature estimation process is executed by the CPU 301 of the ECU 300. Processes of the battery temperature estimation process are called from the higher-order process and executed every predetermined period.

First, the CPU 301 determines whether the battery 100 is at the start of temperature raising (step S111). When the electrode temperature of the battery cell 110 of the battery 100 falls out of a predetermined temperature range suitable for charging and discharging, the efficiency of charging and discharging is reduced. Thus, when the temperature of the battery cell 110 of the battery 100 is lower than the predetermined temperature range, such as when the use of the electricity storage system 10 is started, the cooling and temperature raising device 800 starts temperature raising.

When the CPU 301 determines that the battery 100 is at the start of temperature raising (YES in step S111), the CPU 301 calculates, using a temperature T of the battery cell 110 of the battery 100 detected by the temperature sensor 101, a maximum value A of the estimated temperature difference between the internal temperature and the external temperature of the battery cell 110 of the battery 100 (for example, the external temperature is the temperature detected by the temperature sensor 101, and the internal temperature is the electrode temperature of the battery cell 110) and an estimated required time period B (step S112).

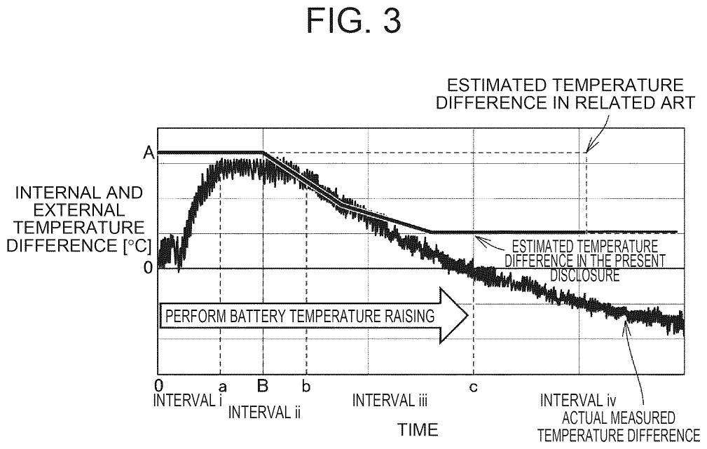

FIG. 3 is a graph showing changes in the difference between the internal temperature and the external temperature of the battery cell 110 of the battery 100 in the present embodiment. Referring to FIG. 3, as shown in the graph of an actual measured temperature difference, in the battery 100, after a sufficiently long time elapses from the previous use, the difference between the temperature detected by the temperature sensor 101 and the electrode temperature of the battery cell 110 (the internal and external temperature difference) approaches 0° C.

When charging of the battery 100 and the temperature raising by the cooling and temperature raising device 800 are started, in an interval i from time 0 to time a, the temperature outside the battery cell 110 rises faster than the temperature inside the battery cell 110, and the internal and external temperature difference thus increases. In an interval ii from time a to time b, the temperature rise inside the battery cell 110 and the temperature rise outside the battery cell 110 become balanced, and the internal and external temperature difference thus maintains a constant value. In an interval iii from time b to time c, the temperature rise inside the battery cell 110 becomes larger than the temperature rise outside the battery cell 110, and the internal and external temperature difference thus decreases. When time c is reached, the internal and external temperature difference becomes zero, and the cooling and temperature raising device 800 stops the temperature raising. In an interval iv after time c, while the electrode temperature rises, the cooling and temperature raising device 800 does not perform temperature raising. Thus, the temperature rise inside the battery cell 110 becomes larger than the temperature rise outside the battery cell 110, and the internal and external temperature difference further decreases.

In this manner, in the battery 100, the maximum value of the internal and external temperature difference during temperature raising and the required time period required for the temperature difference to reach the maximum value from the start of the temperature raising become approximately constant for each model and for each temperature at the start of charging and temperature raising. Thus, it is possible to measure these pieces of data in advance for each model of the battery 100 and create a map showing the maximum value of the internal and external temperature difference during temperature raising and the required time period required for the temperature difference to reach the maximum value for each temperature at the start of charging and temperature raising. The map is stored in advance in the memory 302 of the ECU 300.

Referring back to FIG. 2, in step S112, the CPU 301 calculates the maximum value A of the estimated temperature difference and the estimated required time period B using the map.

When the CPU 301 determines that the battery 100 is not at the start of temperature raising (NO in step S111) or after step S112, the CPU 301 determines whether the temperature raising duration from the start of temperature raising has exceeded the estimated required time period B (step S121).

When the CPU 301 determines that the temperature raising duration is less than the estimated required time period B (NO in step S121), the CPU 301 sets a decrease value C of the estimated temperature difference E to zero (step S123). The decrease value C of the estimated temperature difference E is the value that is decreased from the maximum value A of the estimated temperature difference when the estimated temperature difference E is calculated.

On the other hand, when the CPU 301 determines that the temperature raising duration is not less than the estimated required time period B (YES in step S121), the CPU 301 calculates the decrease value C of the estimated temperature difference E using the temperature raising duration (step S122). For example, the decrease value C for the (N+1)th control cycle that is the next control cycle during the period can be calculated using the formula C=ΔT(N+1)=ΔT(N)×(Kf−1)/Kf. Kf is a time constant.

After step S122 or step S123, the CPU 301 calculates a value as the estimated temperature difference E by subtracting the decrease value C from the maximum value A of the estimated temperature difference (step S124). The CPU 301 determines whether the estimated temperature difference E is equal to or less than a predetermined value D (step S131). When the CPU 301 determines that the estimated temperature difference E is equal to or less than the predetermined value D (YES in step S131), the CPU 301 sets the predetermined value D as the estimated temperature difference E instead of the value calculated in step S124 (step S132).

When the CPU 301 determines that the estimated temperature difference E is not equal to or less than the predetermined value D (NO in step S131), or after step S132, the CPU 301 calculates a value as an internal temperature estimated value F of the battery cell 110 by subtracting the estimated temperature difference E from the temperature T detected by the temperature sensor 101 (step S141). The CPU 301 determines a charging electric power limit value Win corresponding to the internal temperature estimated value F (step S142). The charging electric power limit value Win is determined in advance by experiment or simulation for each model and for each internal temperature of the battery cell 110. After step S142, the CPU 301 returns the process to be executed to the higher-order process that is the caller of the battery temperature estimation process.

Referring again to FIG. 3, by executing the process in FIG. 2, as shown in the graph of the estimated temperature difference in the present disclosure, the estimated temperature difference E is maintained at the maximum value A until the temperature raising duration reaches the estimated required time period B. When the temperature raising duration reaches the estimated required time period B, the estimated temperature difference E is decreased until the estimated temperature difference E reaches the predetermined value D. When the estimated temperature difference E reaches the predetermined value D, the estimated temperature difference E is maintained at the predetermined value D.

The estimated temperature difference in the related art is a large value with a margin until a certain time with a margin elapses after the start of temperature raising, and decreased to a smaller value after the elapse of the certain time.

### Modifications

(1) In the embodiment, the cooling and temperature raising device 800 has the function of cooling the battery 100 and the function of raising the temperature of the battery 100. However, this is not a limitation. The cooling and temperature raising device 800 may have a configuration that does not have the function of cooling the battery 100.

(2) In the embodiment, the electricity storage system 10 has the configuration as shown in FIG. 1. However, this is not a limitation. The electricity storage system 10 may have another configuration that includes the battery 100 including the battery cells 110, the temperature sensor 101, a temperature raising device such as the cooling and temperature raising device 800, and a control apparatus such as the ECU 300. For example, the electricity storage system 10 may have a configuration that does not include the charger 130 or the charging relay 90.

(3) In the embodiment, the decrease value C is calculated using the formula shown in step S122 of FIG. 2. However, this is not a limitation. The decrease value C may be calculated using another formula that calculates the decrease value C such that the decrease value C gradually increases.

(4) The embodiment can be regarded as disclosure of a control apparatus for an electricity storage apparatus, such as the ECU 300, or an electricity storage apparatus, such as the electricity storage system 10, or as disclosure of a control method or a control program executed by a control apparatus as shown in FIG. 2.

### CONCLUSION

(1) As shown in FIG. 1, the ECU 300 is a control apparatus for the electricity storage system 10. As shown in FIG. 1, the electricity storage system 10 includes the battery cell 110, the temperature sensor 101 that detects the temperature of the battery cell 110, and the cooling and temperature raising device 800 that raises the temperature of the battery cell 110. As shown in FIG. 1, the ECU 300 includes the CPU 301. As shown in FIGS. 2 and 3, the CPU 301 determines, from a temperature detected by the temperature sensor 101 when the cooling and temperature raising device 800 starts temperature raising, the estimated maximum value of the temperature difference between the detected temperature and the electrode temperature of the battery cell 110 (e.g., the maximum value A of the estimated temperature difference), and the estimated required time period required for the temperature difference to reach the estimated maximum value (e.g., the estimated required time period B) (e.g., step S112). As shown in FIGS. 2 and 3, when the temperature raising duration of the temperature raising performed by the cooling and temperature raising device 800 exceeds the estimated required time period, the CPU 301 reduces the temperature difference estimated value (e.g., the estimated temperature difference E) of the temperature difference between the temperature detected by the temperature sensor 101 and the electrode temperature while causing the temperature raising to be continued (e.g., step S122, step S124) to increase the electrode temperature estimated value (e.g., the internal temperature estimated value F) of the battery cell 110 (e.g., step S141) and increase the charging electric power limit value (e.g., the charging electric power limit value Win) of the battery cell 110 corresponding to the electrode temperature estimated value (e.g., step S142).

Accordingly, from the temperature detected by the temperature sensor 101 when the temperature raising is started, the estimated maximum value of the temperature difference between the detected temperature and the electrode temperature of the battery cell 110 and the estimated required time period required for the temperature difference to reach the estimated maximum value are determined. When the temperature raising duration exceeds the estimated required time period, the temperature difference estimated value of the temperature difference between the temperature detected by the temperature sensor 101 and the electrode temperature is reduced while the temperature raising is continued, thereby increasing the electrode temperature estimated value of the battery cell 110 and increasing the charging electric power limit value of the battery cell 110 corresponding to the electrode temperature estimated value. Thus, it is possible to increase the charging electric power of the battery cell 110 from the estimated timing at which the temperature difference between the temperature detected by the temperature sensor 101 and the electrode temperature starts to decrease. As a result, the period required for charging can be shortened.

(2) As shown in FIG. 1, the ECU 300 further includes the memory 302. As shown in FIG. 2, the memory 302 may store in advance the map showing the estimated maximum value and the estimated required time period for each temperature detected by the temperature sensor 101 at the start of the temperature raising. The CPU 301 may determine the estimated maximum value and the estimated required time period using the map stored in the memory 302 (e.g., step S112). This makes it possible to more appropriately determine the estimated maximum value and the estimated required time period.

(3) As shown in FIGS. 2 and 3, when the temperature difference estimated value falls below the predetermined value (e.g., the predetermined value D) after the temperature raising duration exceeds the estimated required time period, the CPU 301 may adjust the temperature difference estimated value to the predetermined value (e.g., step S132).

Accordingly, since the temperature difference estimated value of the temperature difference between the temperature detected by the temperature sensor 101 and the electrode temperature is calculated by estimation, it is possible to prevent the charging electric power limit value that is increased in accordance with the temperature difference estimated value from being increased too much.

(4) As shown in FIG. 3, when the temperature difference estimated value becomes zero after the temperature raising duration exceeds the estimated required time period, the CPU 301 may cause the cooling and temperature raising device 800 to finish the temperature raising.

Accordingly, when the temperature difference estimated value of the temperature difference between the temperature detected by the temperature sensor 101 and the electrode temperature becomes zero and the cooling and temperature raising device 800 does not need to perform the temperature raising, it is possible to save electric power consumed by the cooling and temperature raising device 800.

(5) As shown in FIGS. 2 and 3, when the temperature raising duration does not exceed the estimated required time period, the CPU 301 may set the temperature difference estimated value at the estimated maximum value while causing the temperature raising to be continued (e.g., step S123, step S124) to maintain the electrode temperature estimated value of the battery cell 110 at the start of the temperature raising unchanged (e.g., step S141) and maintain the charging electric power limit value corresponding to the electrode temperature estimated value constant (e.g., step S142).

This makes it possible to prevent the charging electric power limit value from being inadvertently increased when it is unclear that the temperature difference estimated value of the temperature difference between the temperature detected by the temperature sensor 101 and the electrode temperature has decreased.

The embodiment disclosed herein should be considered in all respects as illustrative and not restrictive. The scope of the present disclosure is defined by the claims rather than the foregoing description of the embodiment, and is intended to include all changes that fall within the meaning and scope equivalent to the claims.

What is claimed is:

1. A control apparatus for an electricity storage apparatus,
the electricity storage apparatus including
a secondary battery,
a temperature sensor that detects a temperature of the secondary battery, and
a temperature raising device that raises the temperature of the secondary battery, the control apparatus comprising a processor, wherein
the processor
determines, from a temperature detected by the temperature sensor when the temperature raising device starts temperature raising, an estimated maximum value of a temperature difference between the detected temperature and an electrode temperature of the secondary battery, and an estimated required time period required for the temperature difference to reach the estimated maximum value, and
reduces a temperature difference estimated value of the temperature difference between the temperature detected by the temperature sensor and the electrode temperature while causing the temperature raising to be continued to increase an electrode temperature estimated value of the secondary battery and increase a charging electric power limit value of the secondary battery corresponding to the electrode temperature estimated value when a temperature raising duration of the temperature raising performed by the temperature raising device exceeds the estimated required time period.

2. The control apparatus according to claim 1, further comprising a storage unit, wherein:
the storage unit stores in advance a map showing the estimated maximum value and the estimated required time period for each temperature detected by the temperature sensor at the start of the temperature raising; and
the processor determines the estimated maximum value and the estimated required time period using the map stored in the storage unit.

3. The control apparatus according to claim 1, wherein when the temperature difference estimated value falls below a predetermined value after the temperature raising duration exceeds the estimated required time period, the processor adjusts the temperature difference estimated value to the predetermined value.

4. The control apparatus according to claim 1, wherein when the temperature difference estimated value becomes zero after the temperature raising duration exceeds the estimated required time period, the processor causes the temperature raising device to finish the temperature raising.

5. The control apparatus according to claim 1, wherein when the temperature raising duration does not exceed the estimated required time period, the processor sets the temperature difference estimated value at the estimated maximum value while causing the temperature raising to be continued to maintain the electrode temperature estimated value of the secondary battery at the start of the temperature raising unchanged and maintain the charging electric power limit value corresponding to the electrode temperature estimated value constant.
